(19) United States
(12) Patent Application Publication
(10) Pub. No.: US 2015/0213285 A1
(43) Pub. Date: Jul. 30, 2015

(54) CONFIGURATION OF PARTITION RELATIONSHIPS

(71) Applicant: Dante Consulting, Inc., Arlington, VA (US)

(72) Inventors: Pierre Malko, Arlington, VA (US); John C. Gilbert, McLean, VA (US)

(73) Assignee: DANTE CONSULTING, INC., Arlington, VA (US)

(21) Appl. No.: 14/605,197

(22) Filed: Jan. 26, 2015

Related U.S. Application Data
(60) Provisional application No. 61/931,266, filed on Jan. 24, 2014.

(51) Int. Cl. G06F 21/62

(52) U.S. Cl. CPC G06F 21/6218

(57) ABSTRACT

Embodiment of the invention pertains to software architecture and configuration of multi-tenant software. In a multi-tenant architecture, a software application is designed to virtually partition its data and configuration, and each user, group of users, or organization works with a customized virtual application instance. A direct relationship between the tenants, virtual application instances represented as partitions, and the data sets supporting the partitions is provided. Alignment among the tenants, partitions, and data sets may be a vertical alignment or a multi-dimensional alignment. The multi-dimensional alignment may be represented with different configurations, including a one to many relationships of tenants to partitions, a tenant hierarchy relationship with a corresponding partition hierarchy relationship, and a many to many relationship of tenants to shared partitions.

### CROSS REFERENCE TO RELATED APPLICATION(S)

This application is a non-provisional patent application claiming the benefit of the filing date of U.S. Provisional Patent Application Ser. No. 61/931,266 filed Jan. 24, 2014, and titled “Configuration of Partition Relationships” which is hereby incorporated by reference.

### BACKGROUND

The present embodiments relates to software architecture and configuration of multi-tenant software. More specifically, the embodiments pertain to management of sharing characteristics of data across multiple tenants.

A multi-tenancy architecture refers to a principle in software architecture where a single instance of the software runs on a server serving multiple customers, also referred to herein as tenants. A Tenant may be a user, a group of users, or an organization with many users. Multi-tenancy architecture contrasts with the multi-instance architecture. In a multi-instance architecture, a system is configured with a plurality of software instances wherein each software instance separately operates on behalf of a user, group of users, or an organization. In a multi-tenant architecture, a software application is designed to virtually partition its data and configuration, and each user, group of users, or organization works with a customized virtual application instance, also referred to herein as partition.

In a multi-tenant architecture, multiple tenants share the same application, running on the same operating system, on the same hardware, with the same data-storage mechanism. The distinction between the tenants is achieved during application design.

### BRIEF SUMMARY

The embodiments include a method, system, and computer program product for virtualizing sharing of data across tenants.

A method, computer program product, and system are provided for managing data sharing in a multi-tenant architecture having partitioned software architecture. Two or more logical partitions are supported in the architecture. More specifically, a first partition is configured with an application instance and a second partition is configured with the application instance. The first data set is assigned to and supports the first partition, and the second data set is assigned to and supports the second partition. A first tenant in the architecture is assigned to the first partition, and a second tenant is assigned to the second partition. Security is provided by segregating data access according to assignment of a tenant to a partition. In addition, a data sharing relationship is selectively support between the partitions. The sharing relationship enables one of the tenants to be granted access to the data set of another tenant.

Other features and advantages of this invention will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments unless otherwise explicitly indicated. Implications to the contrary are otherwise not to be made.

FIG. 1 depicts a block diagram illustrating the relationships between tenants and partitions and relationships of partitions to data storage in a multi-tenant architecture.

FIG. 2 depicts a block diagram illustrating the relationships among partitions in a multi-tenant system that supports inter-partition sharing.

FIG. 3 depicts a flow chart illustrating the creation of a new tenant partition in a multi-tenant system that supports inter-partition sharing.

FIG. 4 depicts a flow chart illustrating the management of an existing tenant partition in a multi-tenant system that supports inter-partition sharing.

FIG. 5 depicts a flow chart illustrating the effects of inter-partition relationships on user access in a multi-tenant system that supports inter-partition sharing.

FIG. 6 depicts a flow chart illustrating the creation of a child partition to an existing partition.

FIG. 7 depicts a block diagram illustrating tools embedded in a computer system to support the multi-access software instances where the administration application runs on the same server as the managed software instance.

FIG. 8 depicts a block diagram illustrating tools embedded in a computer system to support the multi-access software instances where the administration application runs within the managed software instance.

FIG. 9 depicts a block diagram illustrating tools embedded in a computer system to support multi-access software instances where the administration application runs on a different server than the managed software instance.

FIG. 10 depicts a block diagram showing a system for implementing an embodiment.

FIG. 11 depicts a cloud computing environment.

FIG. 12 depicts a set of functional abstraction layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, and method, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a software instance, data set, client, application, etc., to provide a thorough understanding of embodiments. One skilled in the relevant art will recognize, however, that the embodiments can be practiced without one or more of the specific details, or with other methods, components, materials, etc. In other instances, well known structures, materials, or operations are not shown or described in detail to avoid obscuring aspects.

The illustrated embodiments will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment which may be practiced. It is to be understood that other embodiments may be utilized because structural changes may be made without departing from the scope.

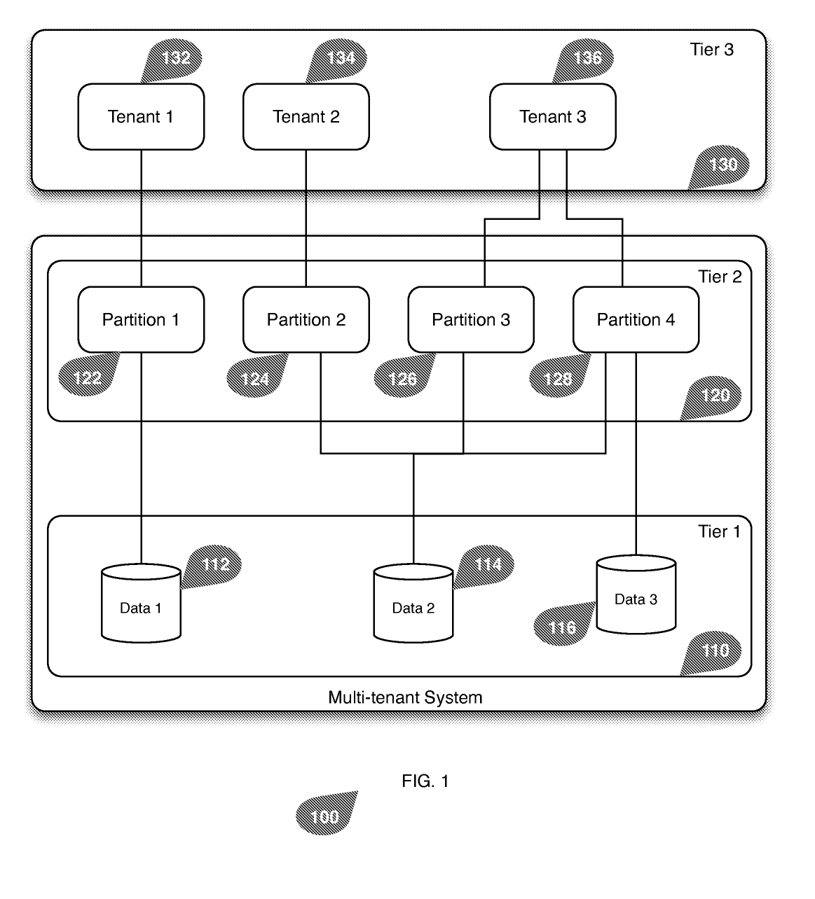

Multi-tenancy provides efficiency with respect to scaling of resources. However, in a multi-tenancy architecture data security is a concern. In one embodiment, it may be desirable to enable and support sharing data in the multi-tenant architecture. Referring to FIG. 1, a block diagram (100) illustrates relationships between tenants and partitions and relationships of partitions to data storage in a multi-tenant architecture. In one embodiment, a partition is a customized virtual application instance within a software application. In one embodiment, a tenant is associated with access privileges to a partition, and by association to a software application instance and a data set. As shown, there are three tiers (110), (120), and (130) shown in the architecture. Tier₁ (110) pertains to data stored in data storage or data in general, tier₂ (120) pertains to software partitions, and tier₃ (130) pertains to tenants. The architecture is a shared system wherein the partitions are configured or configurable to be shared by two or more tenants. Each of these shared partitions has access rights to data that may be common to multiple tenants.

In the example shown in FIG. 1, there are three separate groupings of data in tier₁ (110). Each group represents a segregated data set. Specifically, data₁ (112) refers to a first set of data, data₂ (114) refers to a second set of data, and data₃ (116) refers to a third set of data. In one embodiment and as represented here, data₁ (112), data₂ (114), and data₃ (116) may be located on separate data storage. Similarly, in one embodiment, data₁ (112), data₂ (114), and data₃ (116) may be separate data partitions within the same data storage. In one embodiment, the data may be organized in a database, and the data may have two or more logical partitions. Similarly, the data can run on the same hardware or on different hardware, as explained in detail below.

In addition to the data architecture shown in tier₁ (110), the software partitions are shown in tier₂ (120). Specifically, partition₁ (122) refers to a first software partition configured to run a first virtual application instance, partition₂ (124) refers to a second software partition configured to run a second virtual application instance, partition₃ (126) refers to a third software partition configured to run a third virtual application instance, and partition₄ (128) refers to a fourth software partition configured to run a fourth virtual application instance. In one embodiment, partition₁ (122), partition₂ (124), partition₃ (126), and partition₄ (128) may be located on a single server. Similarly, in one embodiment, partition₁ (122), partition₂ (124), partition₃ (126), partition₄ (128) may be located on a cluster of servers, each in communication with the data partitions shown in tier₁ (110). As shown in the example herein, which is not limiting, partition₁ (122) is shown in communication with data₁ (112), partition₂ (124) and partition₃ (126) are shown in communication with data₂ (114), and partition₄ (128) is shown in communication with data₂ (114) and data₃ (116).

Referring to the data architecture of FIG. 1, the third tier, tier₃ (130), refers to the tenants, and their access privileges to the respective partitions. Different software partitions have access to a select configuration of data partitions. At the same time, different tenants have access to a selection of virtual application instances as represented by the partitions. In the example shown herein, tenant₁ (132) has access privileges to partition₁ (122), tenant₂ (134) has access privileges to partition₂ (124), and tenant₃ (136) has access privileges to partition₃ (126) and partition₄ (128). Each virtual application instance, represented as a logical partition, is assigned as being supported with access to one or more of the segregated data sets. The relationship among the tiers demonstrates access privileges of tenants to logical partitions and to data sets. Accordingly, the relationship of the partition to the data and the tenant to the partition affects the tenant's access to select sets of data.

For descriptive purposes, four partitions are shown and defined herein, although the quantity of partitions should not be considered limiting. Each of the partitions in the second tier, tier₂ (120) are configurable both with respect to the tenants in tier₃, and the data in tier₁ (110). In the example shown herein, tenant₁ (132) has access privileges to the software instance in partition₁ (122), tenant₂ (134) has access privileges to the software instance in partition₂ (124), and tenant₃ (136) has access privileges to the software instance in partition₃ (126) and the software instance in partition₄ (128). At the same time, each of the partitions in the second tier, tier₂ (120), are shown with a one dimensional relationship to data in tier₁ (110). Specifically, the virtual application instance(s) represented in partition₁ (122) is shown with access privileges to data₁ (112), the virtual application instance(s) represented in partition₂ (124), partition₃ (126), and partition₄ (128) are shown with access privileges to data₂ (114), and the virtual application instance(s) represented in partition₄ (128) is shown with access privileges to data₂ (114) and data₃ (116). In one embodiment, any one of the software instances represented in the respective partitions may be configured to have access to two or more sets of data. Accordingly, the data access assignments shown among the tiers in this example should not be considered limiting.

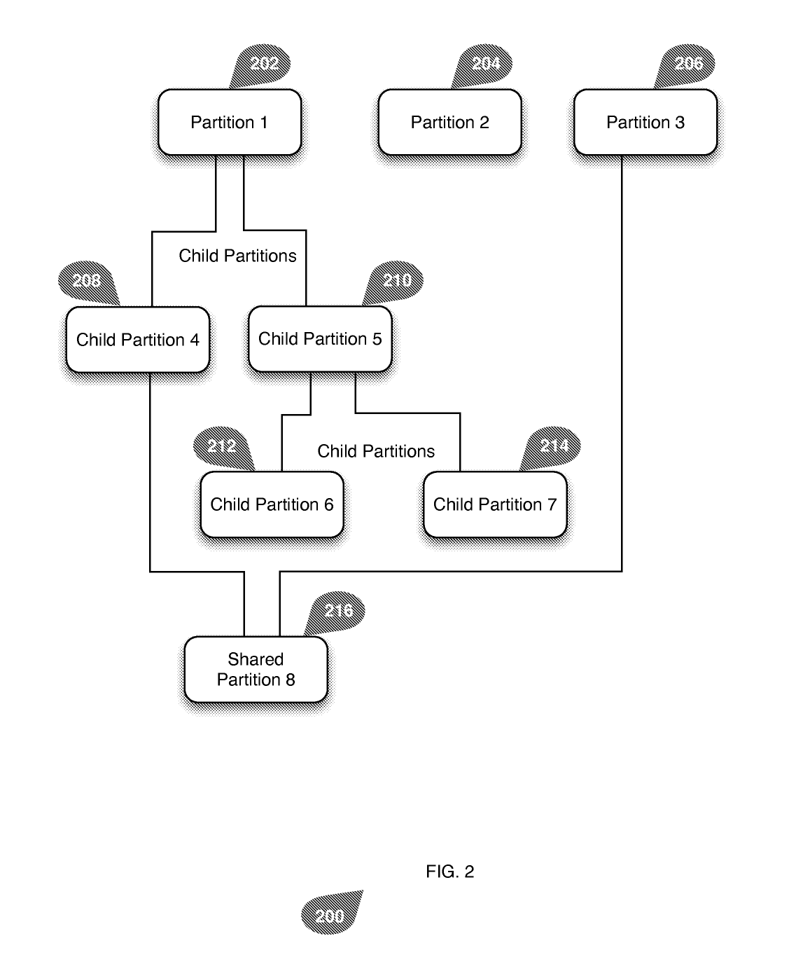

Referring to FIG. 2, a block diagram (200) illustrates the relationships among logical partitions in a multi-tenant system that supports inter-partition sharing. In one embodiment, a partition does not have any sharing relationships with other partitions. As shown, partition₂ (204) has no sharing relationships with any other partitions. In another embodiment, a partition may have a child partition in which case the child partition has its own virtual application instance, but the parent partition has access to the data of the child partition. As shown, partition₁ (202) has two child partitions, child partition₄ (208) and child partition₅ (210). In addition, the diagram shows two child partitions for child partition₅ (210), including child partition₆ (212) and child partition₇ (214). However, in one embodiment, the quantity of child partitions is not limiting. Similarly, in one embodiment, the level of nesting that a partition hierarchy may have is not limiting. In another embodiment, a partition may be shared across multiple partitions in which case the shareable partition has its own virtual application instance, but the other partitions with which it is shared have access to its data. For example, as shown herein shared partition₈ (216) is shared by partition₃ (206) and child partition₄ (208).

As shown in the diagram, the tenant who owns partition₂ (204) has no visibility to the data in any other partition. The tenant in ownership of partition₁ (202) has visibility, also referred to as access, to data in partition₁ (202) and data sets assigned to each related child partition, including child partition₄ (208), child partition₅ (210), child partition₆ (212), and child partition₇ (214). The access to the data is by virtue of the relationship of child partition₅ (210) to partition₆ (212) and partition₇ (214). In addition, by virtue of the relationship of child partition₄ (208) to shared partition₈ (216), the tenant in ownership of partition₁ (202) also has visibility to the data of shared partition₈ (216). The tenant in ownership of partition₃ (206) has visibility to the data in both partition₃ (206) and shared partition₈ (216). The tenant in ownership of child partition₄ (208) has visibility to the data in both child partition₄ (208) and shared partition₈ (216). At the same time, the tenant in ownership of child partition₄ (208) does not have access privileges to data associated with its parent partition₁ (202). The tenant in ownership of child partition₅ (210) has visibility to the data in each of child partition₅ (210), child partition₆ (212), and child partition₇ (214), but does not have access privileges to data with its parent partition₁ (202). The tenant in ownership of child partition₆ (212) has visibility limited to the data in child partition₆ (212); the tenant in ownership of child partition₇ (214) has visibility limited to the data in child partition₇ (214); and does not have access privileges to data with its parent partition₅ (210) or its grandparent partition₁ (202). The tenant in ownership of shared partition₈ (216) has visibility limited to the data in shared partition₈ (216), but does not have access privileges to data with its parent partitions (208) and (206) and its grandparent partition (202). Although the example shown herein is limited to one shared partition, e.g. shared partition₈ (216), in one embodiment there may be a plurality of shared partitions in the system. Also, referring to FIG. 1, the same tenant may own multiple partitions. Accordingly, any one tenant may own one or more partitions.

The hierarchical relationship shown and described in FIG. 2 is unidirectional with respect to parent partitions and access rights to data in one or more child and/or grandchild partitions. In one embodiment, the access privileges may be bi-directional, if explicitly defined. Shared partition₈ (216) is shared by partition₃ (206), child partition₄ (208) and partition₁ (202). In one embodiment, shared partition₈ (216) is a database of products. Partition₁ (202), child partition₄ (208), and partition₃ (206) have access privileges to the shareable data in shared partition₈ (216). As a new product or new data is added to shared partition₈ (216), the data will be shared by the tenants in (202), (206) and (208). In the multiple tenant configuration shown herein data sharing is enabled between tenants as designated. In one embodiment, the sharing configuration is designated when the shared partition₈ (216) is created. In one embodiment, the partition hierarchy shown herein may correspond to an organizational hierarchy. For example, a parent company may have one or more subsidiaries. The parent company may be represented as a parent partition, and each subsidiary may be represented as a child partition. In another embodiment, the partition sharing may correspond to a wholesaler-retailer relationship, with the wholesaler having a shareable partition and one or more of the retailers each having its own partition with a sharing relationship to the shareable partition of the wholesaler. In another embodiment, the partition sharing may be employed in a multi-provider model with each provider having a separate shareable partition and each retailer with its own partition having a sharing relationship to its provider(s) partition(s). In one embodiment, one tenant may be a white label provider having created a solution that can be private labeled and designated as a parent in the hierarchy of partitioned data sets, and an associated child tenant may be a solution provider subscribing to the white label. Accordingly, in the example shown herein the shareable data in shared partition₈ (216) is shared by a plurality of tenants.

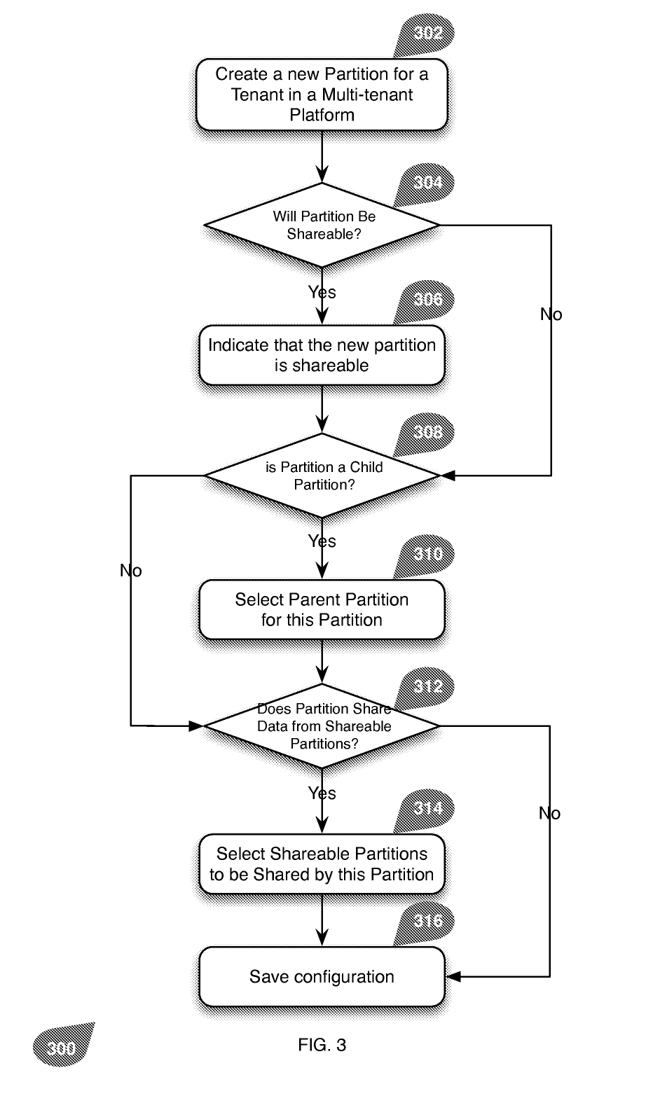

Referring to FIG. 3, a flow chart (300) is provided demonstrating an aspect of creating a new tenant partition in a multi-tenant system that supports inter-partition sharing. As shown, a new partition is created. There are different characteristics associated with partitions. In the scenario described herein, a new partition is created in a multi-tenant platform (302). More specifically, a new virtual application instance of a software application is created, with corresponding data to the partition possibly being accessible by one or more tenants in the computing environment. Following the creation at step (302), it is determined if the new partition is configured as being accessible by at least one other tenant partition (304). A positive response to the determination at step (304) is followed by indicating that the new partition is shareable (306). Following the designation at step (306) or a negative response to the determination at step (304), it is determined whether the new partition is being placed in a hierarchical structure and as a child of another partition (308). A positive response to the determination at step (308) is followed by selecting a parent partition for the new partition (310). Following completion of the selection at step (310) or a negative reply to the determination at step (308), a determination is made on whether the partition can share data from any other partitions in the platform that are designated as shareable (312). A positive response to the determination at step (312) is followed by selecting one or more shareable partitions to be shared by the new partition (314). Following the selection at step (314) or a negative response to the determination at step (312), the configuration of the new partition is saved (316).

As shown in FIGS. 1 and 2, there is a direct relationship between the tenants, the virtual application instances represented as partitions, and the data sets supporting the partitions. The tenants access one software instance. Each partition with different data sets and data access privileges has a different look and representation. More specifically, the software instances look different based on the data sharing designations. In one embodiment, this alignment is referred to as a vertical alignment. Data sharing in the vertical alignment is unidirectional with a parent accessing data of a child, but the child cannot access non-shared data of the parent unless explicitly granted access. In another embodiment, a multi-dimensional alignment of virtual application instances to both the data sets and the tenants can be achieved. The multi-dimensional alignment may be represented with different configurations, including but not limited to a one to many relationship of tenants to partitions, a tenant hierarchy relationship with a corresponding partition hierarchy relationship, and a many to many relationship of tenants to shared partitions.

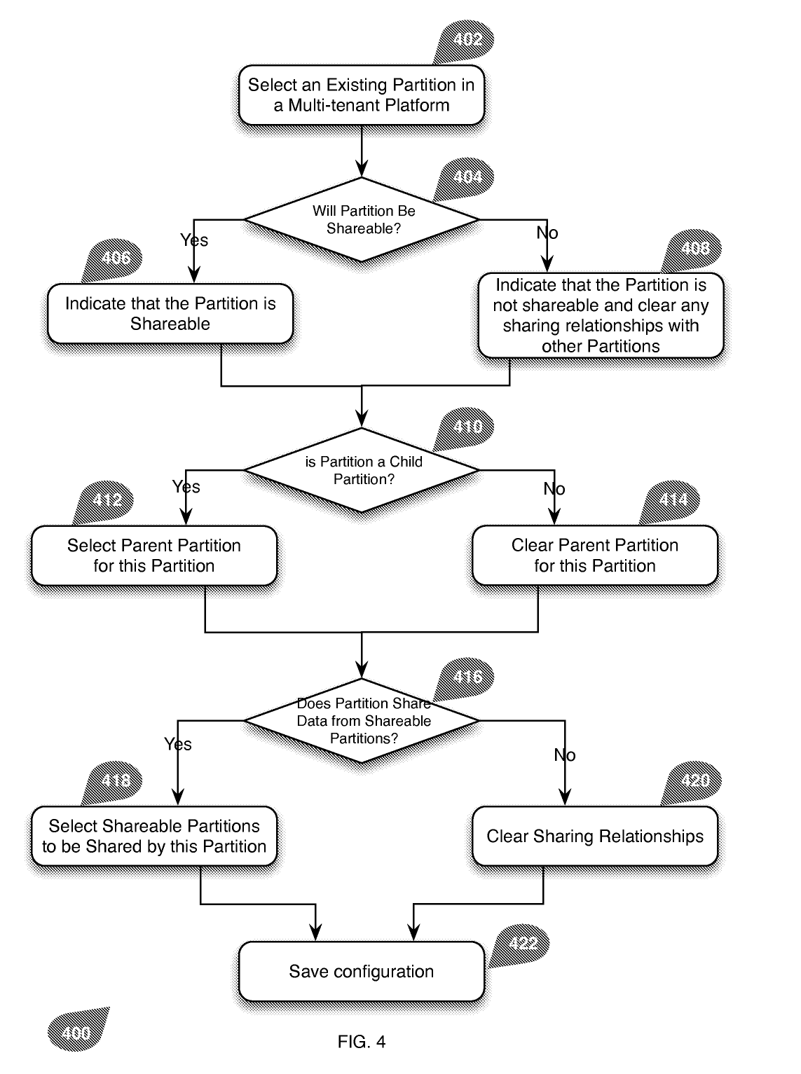

Referring to FIG. 4, a flow chart (400) is provided demonstrating an aspect of the management of an existing tenant partition in a multi-tenant system that supports inter-partition sharing. As shown, an existing partition in a multi-tenant platform is selected (402). In one embodiment, one or more characteristics of the selected partition are modified following the selection at step (402). As shown herein, a determination is made as to whether the selected partition should be shareable (404). Based on that determination, the partition is configured accordingly (406) and (408). Specifically, if the partition is marked as shareable, then the partition is indicated as such (406), and if the partition is marked as non-shareable, then the partition is indicated as not shareable and any sharing relationship with other partitions is cleared (408). Following the indications at steps (406) or (408), it is determined whether the selected partition should be a child partition (410). Based on that determination, the partition is configured accordingly (412) and (414). Specifically, if the partition is selected to be a child partition, then the parent partition for the child partition is selected (412). Otherwise, the parent partition for this selected partition is cleared (414). Following the actions at steps (412) or (414), it is determined whether the selected partition should share data from any of the shareable partitions in the platform (416). Based on that determination, the selected partition is configured accordingly (418) and (420). Specifically, a positive response to the determination at step (416) is followed by selecting one or more shareable partitions to be shared by the subject partition (418), and a negative response to the determination at step (416) is followed by clearing the sharing relationships with the subject partition (420). Following the completion of the actions at either step (418) or (420), the configuration of the selected partition is saved (422).

As shown at step (406), the selected partition may be configured to be shareable. Similarly, as shown at step (412), the selected partition is modified to be a child of an existing partition. The action and configuration taken at step (412) re-configures the selected partition into a hierarchical relationship with an existing partition. Finally, as shown at step (418) the selected partition may be modified to establish a relationship with one or more shareable partitions.

In one embodiment, the re-configuration of the partition, may change access privileges of a tenant to the partition and/or change the access privileges of the tenant to one or more sets of data. Configuration of a partition establishes the data and the tenant relationships. Accordingly, the configuration, or in one embodiment re-configuration, of a partition may inherently affect the access rights of an associated tenant to other partitions and/or their underlying data.

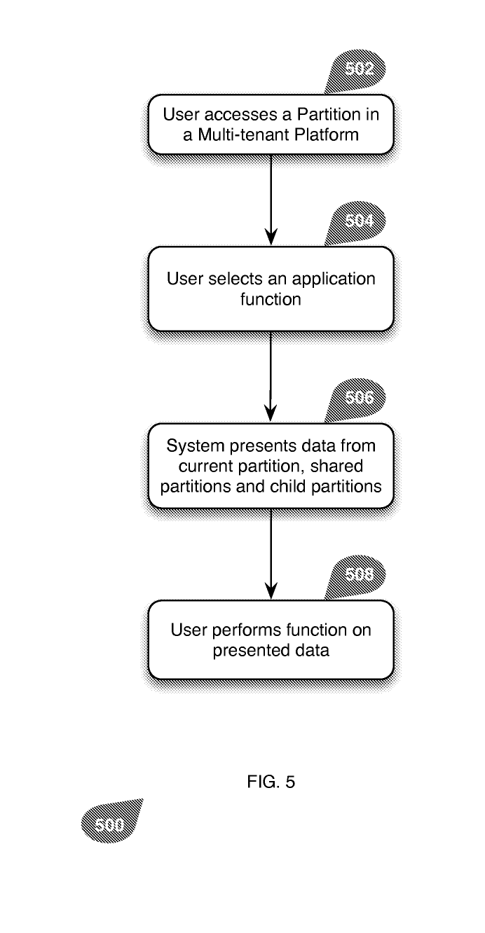

Referring to FIG. 5, a flow chart (500) is provided illustrating the effects of inter-partition relationships on user access in a multi-tenant system that supports inter-partition sharing. As shown, a user accesses a partition in a multi-tenant platform (502), and based on authorization of the access, the user selects an application function (504). In response to the function selection, the system presents data (506). Based on the hierarchical position of the partition, data presented at step (506) may be from the current partition, any shared partitions, any child partitions, and recursively any children of the child partitions. The user then performs one or more operations using the presented data (508).

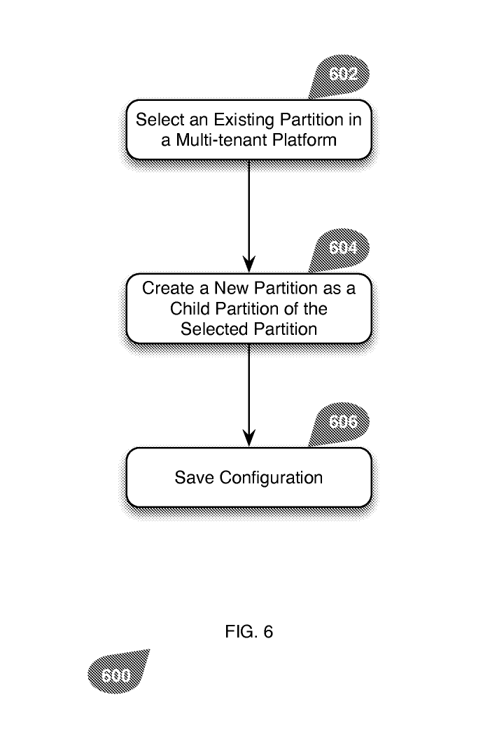

Existing software instances may be re-configured. In addition, an existing hierarchy of instances may be modified to accommodate a new partition. FIG. 6 is a flow chart (600) illustrating a process for creating a child partition in an existing arrangement of partitions. As shown, as existing partition in a multi-tenant platform is selected (602). A new partition is created in the arrangement, with the new partition designated as a child partition of the selected partition (604). Following the designation of the new partition, the configuration of partitions is saved. Accordingly, a new partition may be amended into an existing hierarchical arrangement of partitions, which inherently enables any parent partition access to data in the new child partition.

As will be appreciated by one skilled in the art, aspects of the present embodiments may be embodied as a system, method or computer program product. Accordingly, aspects of the present embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The functional unit(s) described in this specification has been labeled with tools in the form of manager(s). A manager may be implemented in programmable hardware devices such as field programmable gate arrays, programmable array logic, programmable logic devices, or the like. The manager(s) may also be implemented in software for processing by various types of processors. An identified manager of executable code may, for instance, comprise one or more physical or logical blocks of computer instructions which may, for instance, be organized as an object, procedure, function, or other construct. Nevertheless, the executable of an identified manager need not be physically located together, but may comprise disparate instructions stored in different locations which, when joined logically together, comprise the managers and achieve the stated purpose of the managers and directors.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

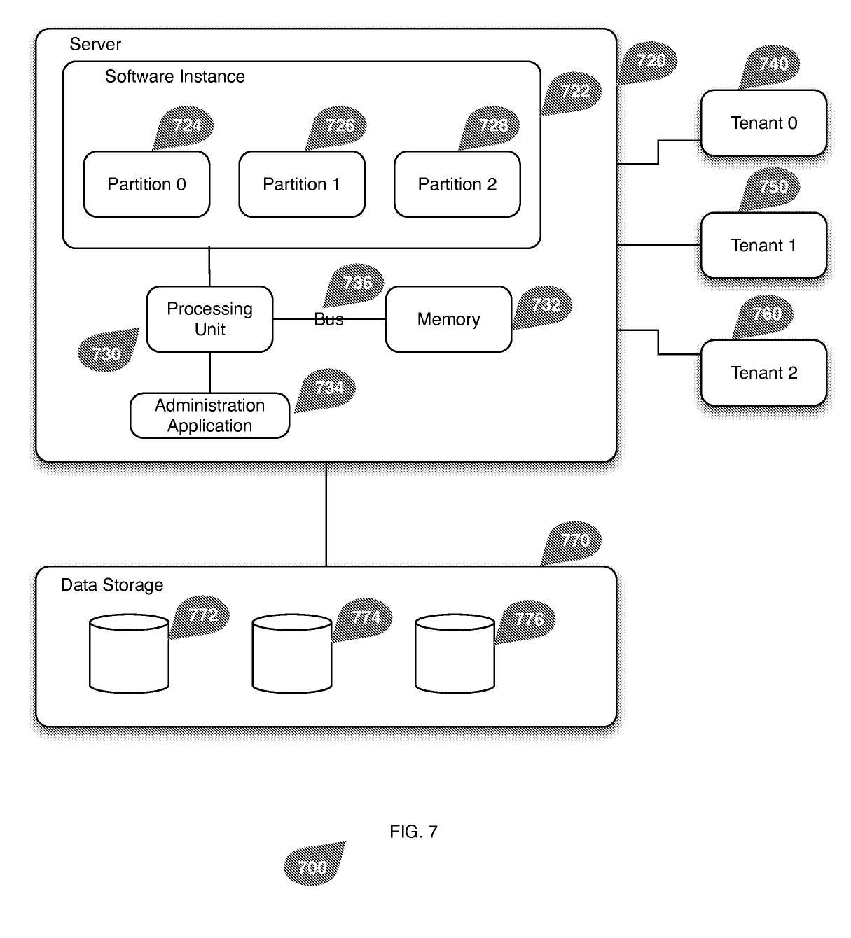

FIG. 7 is a block diagram (700) illustrating tools embedded in a computer system to support multi-access software instances where an administration application runs on the same server as the managed software instance. A server (720) is provided in the system with a processing unit (730) in communication with memory (732) across a bus (736). The processing unit (730) is shown in communication with both a software instance (722) and an administrative application (734). The software instance (722) is shown with multiple partitions (724), (726), and (728). Although only three partitions are shown, this quantity should not be considered limiting.

Three tenants (740), (750), and (760) are each shown in communication with the server (720), and specifically, the partitions (724)-(728) of the software instance (722). Configuration of the partitions (724)-(728) and access privileges by the tenants (740), (750), and (760) is managed by the administration application (734). In addition, as shown, data storage (770) is provided in communication with the server (720). In the embodiment shown herein, data storage (770) is shown with three storage devices (772), (774), and (776), although this quantity is not limiting. The software instance (772) may be provided access privileges to data on one or more of the storage devices (772), (774), and (776), or in one embodiment to one or more designated data sets within one of the storage devices. Similarly, in one embodiment, each storage device may be configured with one or more partitions of data, each referred to herein as a data set. Different software instances of application software (722) may be represented by access privileges to select data partitions. For example, a representation of software (722) with one data set may look different from another representation of software (722) with a different data set. In one embodiment, the software instances and/or the storage devices may be present on a shared group of resources, i.e. a cloud computing environment, and remain configurable as described herein.

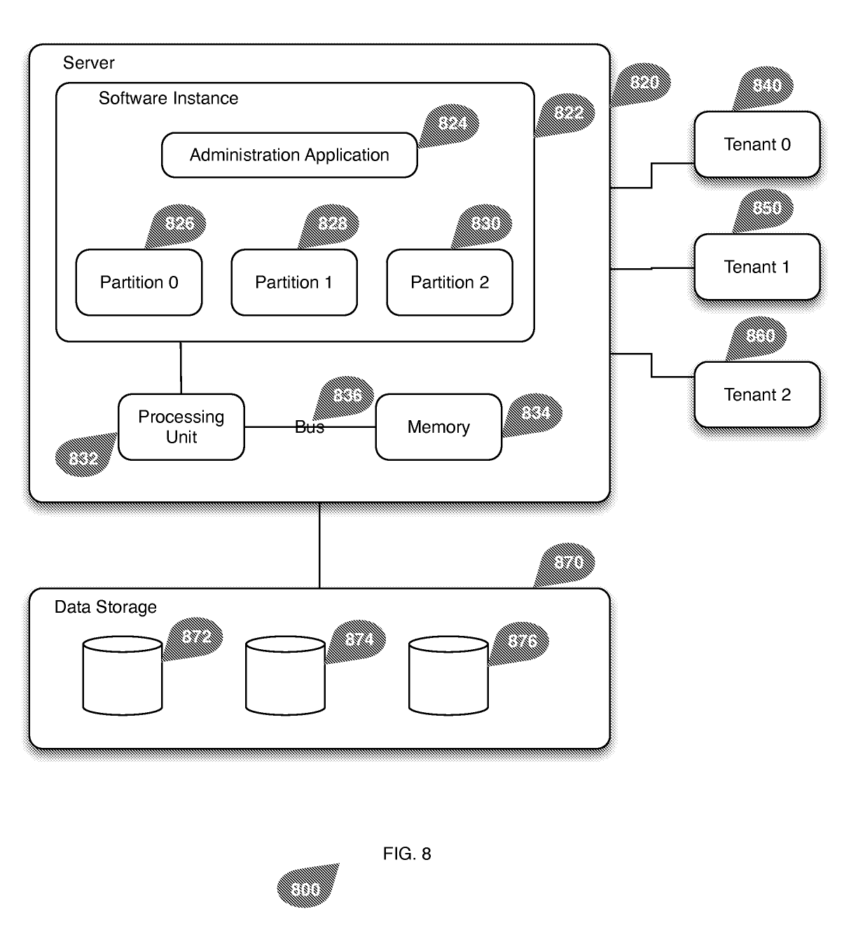

FIG. 8 is a block diagram (800) illustrating tools embedded in a computer system to support the multi-access software instances where the administration application runs within the managed software instance. A server (820) is provided in the system with a processing unit (832) in communication with memory (834) across a bus (836). The processing unit (830) is shown in communication a software instance (822). The software instance (822) is shown with an administrative application (824) and multiple partitions, namely partition₀ (826), partition₁ (828), and partition₂ (830). Although only three partitions are shown, this quantity should not be considered limiting.

Three tenants, namely, tenant₀ (840), tenant₁ (850), and tenant₂ (860) are each shown in communication with the server (820), and specifically, the partitions (826)-(830) of the software instance (822). Configuration of the partitions (826)-(830) and access privileges by the tenants (840), (850), and (860) is managed by the embedded administration application (824). In addition, as shown, data storage (870) is provided in communication with the server (820). In the embodiment shown herein, data storage (870) is shown with three storage devices (872), (874), and (876), although this quantity is not limiting. In one embodiment, the software instance (822) may be provided access privileges to data on one or more of the storage devices (872), (874), and (876). Similarly, in one embodiment, each storage device may be configured with one or more partitions of data, and the software instance (822) may be provided access privileges to select data partitions as defined and/or authorized by application (824). Furthermore, in one embodiment, the software instances and/or the storage devices may be present on a shared group of resources, i.e. a cloud computing environment, and remain configurable as described herein.

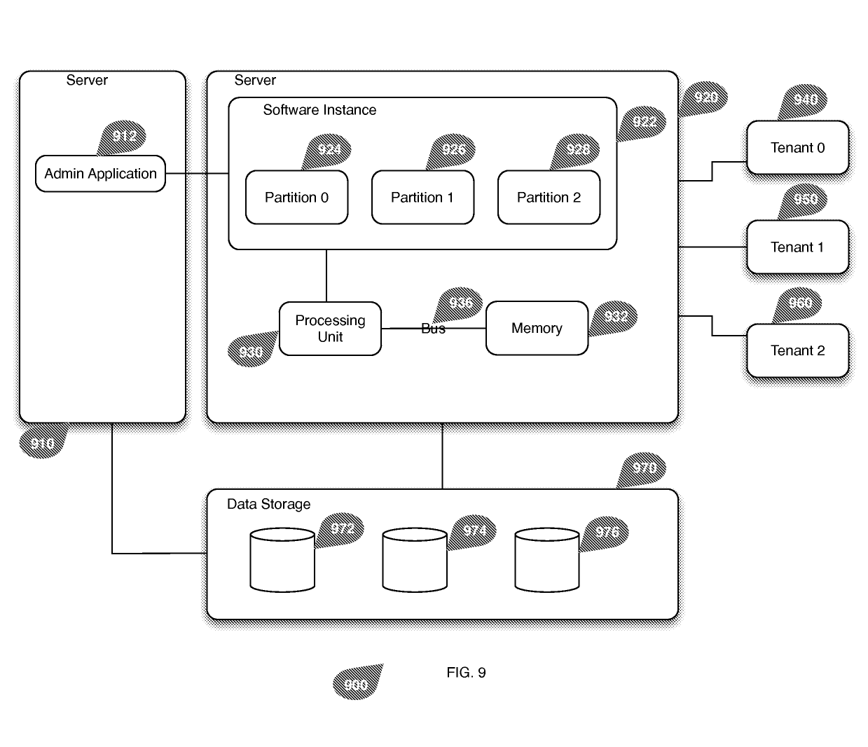

Referring to FIG. 9, a block diagram (900) is provided illustrating tools embedded in a computer system to support multi-access software instances where the administration application runs on a different server than the managed software. A server (920) is provided in the system with a processing unit (930) in communication with memory (932) across a bus (934). The processing unit (930) is shown in communication a software instance (922). The software instance (922) is shown with a plurality of embedded partitions, namely partition₀ (924), partition₁ (926), and partition₂ (928). Although only three partitions are shown, this quantity should not be considered limiting.

Three tenants, namely, tenant₀ (940), tenant₁ (950), and tenant₂ (960) are each shown in communication with the server (920), and specifically, the partitions (924)-(928) of the software application (922). Configuration of the partitions (924)-(928) and access privileges by the tenants (940), (950), and (960) is managed by an administrative application (912) in communication with the software instance (922). As shown, a server (910) is provided in communication with server (920), and includes an embedded administrative application (912). In addition, as shown, data storage (970) is provided in communication with the server (920). In the embodiment shown herein, data storage (970) is shown with three storage devices (972), (974), and (976), although this quantity is not limiting. In one embodiment, the software instance (922) may be provided access privileges to data on one or more of the storage devices (972), (974), and (976). Similarly, in one embodiment, each storage device may be configured with one or more partitions of data, and the software instance (922) may be provided access privileges to select data partitions. Each software instance (922) with different data access may have a different look. Furthermore, in one embodiment, the software instance (922) and/or the storage devices may be present on a shared group of resources, i.e. a cloud computing environment, and remain configurable as described herein.

Sharing of data minimizes data duplication and improves data storage and associated data management. Specifically, sharing minimizes redundancy because there is no need to duplicate copies of data. At the same time, the data sharing described herein improves aspects of data sharing by placing limitations and structure to the sharing. The limitations described establish security barriers. A single software instance may be utilized by one or more tenants, such that the same software instance may support multiple tenants with different assignments or combinations of data access privileges.

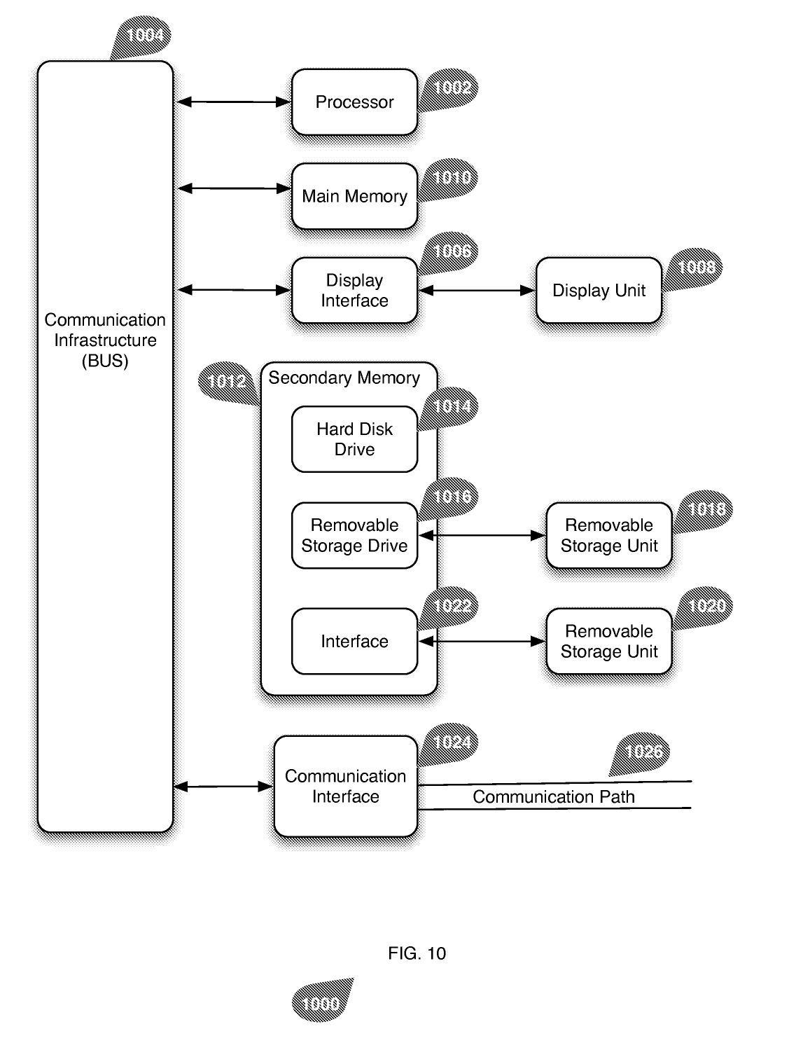

Referring now to the block diagram (1000) of FIG. 10, additional details are now described with respect to implementing an embodiment of the present invention. The computer system includes one or more processors, such as a processor (1002). The processor (1002) is connected to a communication infrastructure (1004) (e.g., a communications bus, cross-over bar, or network).

The computer system can include a display interface (1006) that forwards graphics, text, and other data from the communication infrastructure (1004) (or from a frame buffer not shown) for display on a display unit (1008). The computer system also includes a main memory (1010), preferably random access memory (RAM), and may also include a secondary memory (1012). The secondary memory (1012) may include, for example, a hard disk drive (1014) (or alternative persistent storage device) and/or a removable storage drive (1016), representing, for example, a floppy disk drive, a magnetic tape drive, or an optical disk drive. The removable storage drive (1016) reads from and/or writes to a removable storage unit (1018) in a manner well known to those having ordinary skill in the art. Removable storage unit (1018) represents, for example, a floppy disk, a compact disc, a magnetic tape, or an optical disk, etc., which is read by and written to by a removable storage drive (1016). As will be appreciated, the removable storage unit (1018) includes a computer readable medium having stored therein computer software and/or data.

In alternative embodiments, the secondary memory (1012) may include other similar means for allowing computer programs or other instructions to be loaded into the computer system. Such means may include, for example, a removable storage unit (1020) and an interface (1022). Examples of such means may include a program package and package interface (such as that found in video game devices), a removable memory chip (such as an EPROM, or PROM) and associated socket, and other removable storage units (1020) and interfaces (1022) which allow software and data to be transferred from the removable storage unit (1020) to the computer system.

The computer system may also include a communications interface (1024). Communications interface (1024) allows software and data to be transferred between the computer system and external devices. Examples of communications interface (1024) may include a modem, a network interface (such as an Ethernet card), a communications port, or a PCMCIA slot and card, etc. Software and data transferred via communications interface (1024) are in the form of signals which may be, for example, electronic, electromagnetic, optical, or other signals capable of being received by communications interface (1024). These signals are provided to communications interface (1024) via a communications path (i.e., channel) (1026). This communications path (1026) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (1010) and secondary memory (1012), removable storage drive (1016), and a hard disk installed in hard disk drive or alternative persistent storage device (1014).

Computer programs (also called computer control logic) are stored in main memory (1010) and/or secondary memory (1012). Computer programs may also be received via a communication interface (1024). Such computer programs, when run, enable the computer system to perform the features of the present invention as discussed herein. In particular, the computer programs, when run, enable the processor (1002) to perform the features of the computer system. Accordingly, such computer programs represent controllers of the computer system.

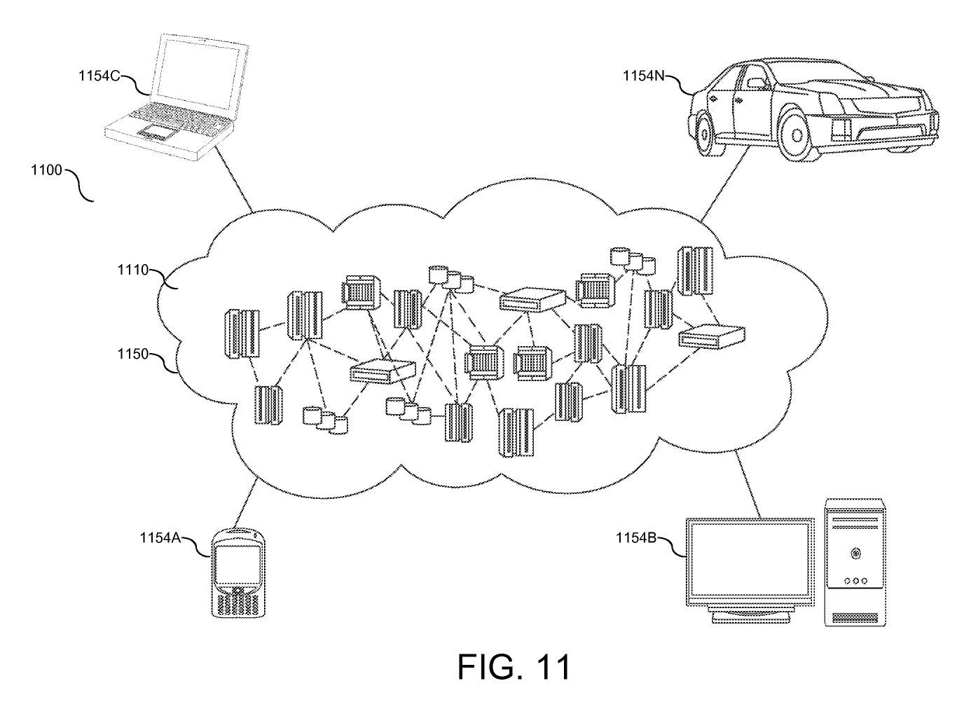

The partitions, software instances, and data sets may be employed in a distributed computing system. In one embodiment, the partitions, software instances, and data sets and the associated configuration(s) and access privilege(s) are employed in a shared pool of configurable resources, also referred to herein as a cloud computing environment. Referring to FIG. 11, a cloud computing environment (1100) is depicted. As shown, the cloud computing environment (1150) comprises one or more cloud computing nodes (1110) with which local computing devices used by cloud consumers, such as, for example, personal digital assistant (PDA) or cellular telephone (1154A), desktop computer (1154B), laptop computer (1154C), and/or automobile computer system (1154N) may communicate. Nodes (1110) may communicate with one another. They may be grouped (not shown) physically or virtually, in one or more networks, such as Private, Community, Public, or Hybrid clouds as described hereinabove, or a combination thereof. This allows cloud computing environment (1150) to offer infrastructure, platforms, and/or software as services for which a cloud consumer does not need to maintain resources on a local computing device. It is understood that the types of computing devices (1154A)-(1154N) shown in FIG. 11 are intended to be illustrative only and that computing nodes (1110) and cloud computing environment (1150) can communicate with any type of computerized device over any type of network and/or network addressable connection (e.g., using a web browser).

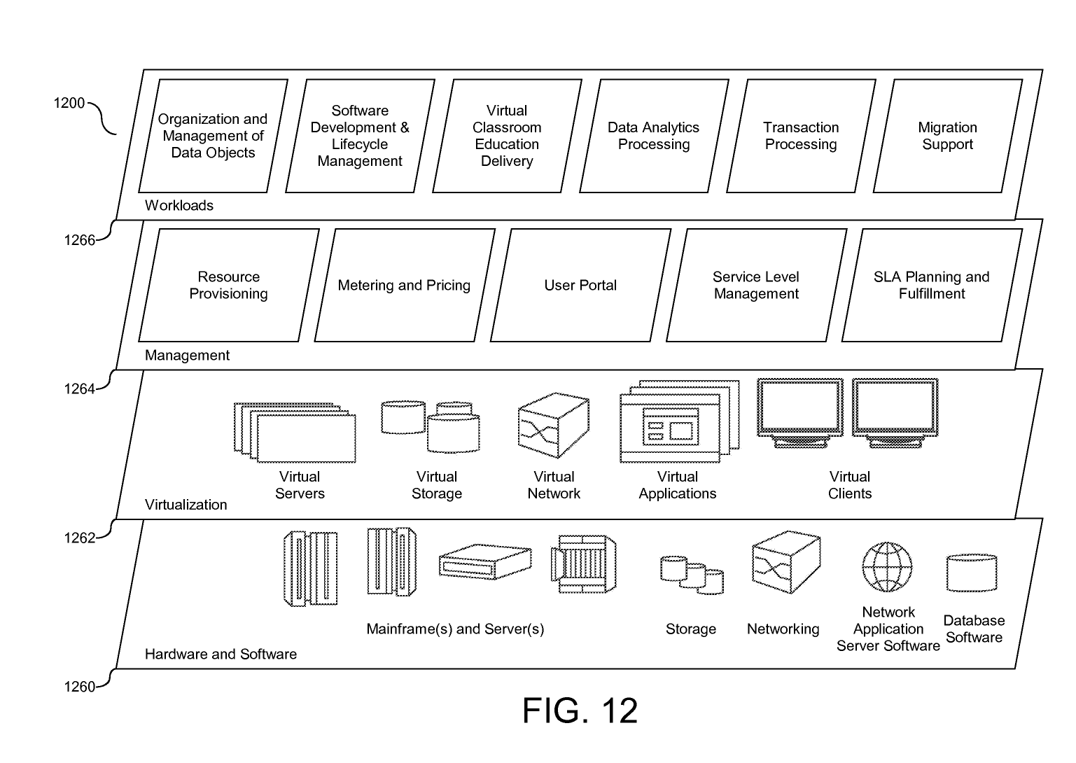

Referring now to FIG. 12, a set of functional abstraction layers provided by cloud computing environment (1200) is shown. It should be understood in advance that the components, layers, and functions shown in FIG. 12 are intended to be illustrative only and embodiments are not limited thereto. As depicted, the following layers and corresponding functions are provided: hardware and software layer (1210), virtualization layer (1220), management layer (1230), and workload layer (1240). The hardware and software layer (1210) includes hardware and software components. Examples of hardware components include servers, storage devices, and networks and networking components. Examples of software components include network application server software.

Virtualization layer (1220) provides an abstraction layer from which the following examples of virtual entities may be provided: virtual servers; virtual storage; virtual networks, including virtual private networks; virtual applications and operating systems; and virtual clients.

In one example, a management layer (1230) may provide the following functions: resource provisioning, metering and pricing, user portal, service level management, and key management. The functions are described below. Resource provisioning provides dynamic procurement of computing resources and other resources that are utilized to perform tasks within the cloud computing environment. Metering and pricing provides cost tracking as resources that are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Management provides cloud computing and sharing of data among two or more entities such that required management of associated data is met.

Workloads layer (1240) provides examples of functionality for which the cloud computing environment may be utilized. In the shared pool of configurable computer resources described herein, hereinafter referred to as a cloud computing environment, files may be shared among users within multiple data centers, also referred to herein as data sites. Accordingly, a series of mechanisms are provided within the shared pool to support organization and management of data storage within the cloud computing environment.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Specifically, the embodiments are directed to improving data security in a distributed storage environment. Accordingly, the enhanced configuration of shared software instances supports flexibility with respect to transaction processing, including, but not limited to, optimizing the storage system and processing transactions responsive to the optimized storage system.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

What is claimed is:

1. A method for managing data sharing in a partitioned software architecture, comprising:
configuring a first logical partition within an application instance and a first data set supporting the first partition, and configuring a second logical partition within the application instance and assigning a second data set supporting the second partition in the application instance;
assigning a first tenant in a multi-tenant architecture to the first logical partition and a second tenant to the second logical partition;
providing data security, including associating each data set with one of the logical partitions and segregating data access according to assignment of a tenant to a partition;
selectively designating a data sharing relationship between the partitions, wherein the sharing includes granting the first tenant access to the second data set.

2. The method of claim 1, further the data sharing relationship between partitions establishing a security barrier.

3. The method of claim 1, further comprising designating one of the logical partitions as a shared partition, wherein the shared designation allows one or more tenants of another logical partition access to a data set assigned to the shared partition.

4. The method of claim 1, further comprising designating one of the logical partitions as a shared partition, wherein the shared designation allows two or more tenants access to a data set assigned to the partition.

5. The method of claim 1, further comprising organizing the logical partitions into a hierarchy of partitions, wherein the hierarchy includes a parent partition and a child partition, each partition having at least one assigned data set.

6. The method of claim 5, further comprising creating a new logical partition and amending the new partition into the hierarchy, including assigning the new logical partition to a select position within the hierarchy.

7. The method of claim 5, further comprising at least three generations of partitions in the hierarchy, wherein the child partition is the parent of a second child partition and the parent partition is the grandparent partition to the second child partition.

8. The method of claim 1, further comprising an assigned tenant accessing one of the logical partitions and selecting an application function, and presenting data in response to the function selection, wherein the data is presented from the data set assigned to the accessed partition and any data set assigned to any partition selected from the group consisting of: a shared partition, a child partition, and any children of the child partition.

9. The method of claim 1, wherein tenant sharing of data is designated when the partition is created.

10. The method of claim 1, wherein tenant sharing of data is designated after the partition is created.

11. The method of claim 1, wherein first tenant is a retailer and the second tenant is a wholesaler.

12. The method of claim 1, wherein the first tenant is a broker and the second tenant is a provider.

13. The method of claim 5, wherein the hierarchy represents a corporate structure.

14. The method of claim 13, wherein a parent position with the hierarchy represents a company and a child position with the hierarchy represents an affiliate.

15. The method of claim 13, wherein the first tenant is a white label provider and the second tenant is a solution provider.

16. The method of claim 1, wherein the data sharing relationship between the partitions reduces creation of duplicate data.

17. A computer program product for managing data sharing in a partitioned software architecture, the computer program product comprising a compute readable storage device having program code embodied therewith, the program code executable by a processing unit to:
configure a first logical partition within an application instance and a first data set supporting the first partition, and configure a second logical partition within the application instance and assigning a second data set supporting the second partition in the application instance;
assign a first tenant in a multi-tenant architecture to the first logical partition and a second tenant to the second logical partition;
improve data security, including associate each data set with one of the logical partitions and segregate data access according to assignment of a tenant to a partition;
selectively designate a data sharing relationship between the partitions, wherein the sharing includes granting the first tenant access to the second data set.

18. The computer program product of claim 17, wherein the data sharing relationship between partitions establishes a security barrier.

19. The computer program product of claim 17, further comprising program code to designate one of the logical partitions as a shared partition, wherein the shared designation allows one or more tenants of another logical partition access to a data set assigned to the shared partition.

20. The computer program product of claim 17, further comprising program code to designate one of the logical partitions as a shared partition, wherein the shared designation allows two or more tenants access to a data set assigned to the partition.

21. The computer program product of claim 17, further comprising program code to organize the logical partitions into a hierarchy of partitions, wherein the hierarchy includes a parent partition and a child partition, each partition having at least one assigned data set.

22. The computer program product of claim 21, further comprising program code to create a new logical partition and amend the new partition into the hierarchy, including the program code to assign the new logical partition to a select position within the hierarchy.

23. The computer program product of claim 21, further comprising at least three generations of partitions in the hierarchy, wherein the child partition is the parent of a second child partition and the parent partition is the grandparent partition to the second child partition.

24. The computer program product of claim 21, wherein the hierarchy represents a corporate structure.

25. The computer program product of claim 17, further comprising an assigned tenant accessing one of the logical partitions and selecting an application function, and program code to present data in response to the function selection, wherein the data is presented from the data set assigned to the accessed partition and any data set assigned to any partition selected from the group consisting of: a shared partition, a child partition, and any children of the child partition.

26. The computer program product of claim 17, wherein tenant sharing of data is designated when the partition is created.

27. The computer program product of claim 17, wherein tenant sharing of data is designated after the partition is created.

28. The computer program product of claim 17, wherein the data sharing relationship between the partitions reduces creation of duplicate data.

29. A computer system comprising:
a processing unit in communication with data storage;
an application in communication with the processing unit to manage data sharing in a partitioned software architecture, including:
the application to configure a first logical partition within an application instance and a first data set supporting the first partition, and configure a second logical partition within the application instance and assigning a second data set supporting the second partition in the application instance;
the application to assign a first tenant in a multi-tenant architecture to the first logical partition and a second tenant to the second logical partition;
the application to transform data security, including segregation of data and control of data access according to assignment of a tenant to a partition;
the application to selectively designate a data sharing relationship between the partitions, wherein the sharing includes granting the first tenant access to the second data set.

30. The system of claim 29, wherein the data sharing relationship between partitions establishes a security barrier.

31. The system of claim 29, further the application to designate one of the logical partitions as a shared partition, wherein the shared designation allows one or more tenants of another logical partition access to a data set assigned to the shared partition.

32. The system of claim 29, further comprising the application to designate one of the logical partitions as a shared partition, wherein the shared designation allows two or more tenants access to a data set assigned to the partition.

33. The system of claim 29, further comprising the application to organize the logical partitions into a hierarchy of partitions, wherein the hierarchy includes a parent partition and a child partition, each partition having at least one assigned data set.

34. The system of claim 33, further comprising the application to create a new logical partition and amend the new partition into the hierarchy, including assign the new logical partition to a select position within the hierarchy.

35. The system of claim 33, further comprising at least three generations of partitions in the hierarchy, wherein the child partition is the parent of a second child partition and the parent partition is the grandparent partition to the second child partition.

36. The system of claim 33, wherein the hierarchy represents a corporate structure.

37. The system of claim 29, further comprising the application to authorize an assigned tenant access to one of the logical partitions and selection of an application function, and data presented in response to the function selection, wherein the data is presented from the data set assigned to the accessed partition and any data set assigned to any partition selected from the group consisting of: a shared partition, a child partition, and any children of the child partition.

38. The system of claim 29, wherein tenant sharing of data is designated when the partition is created.

39. The system of claim 29, wherein tenant sharing of data is designated after the partition is created.

40. The system of claim 17, wherein the data sharing relationship between the partitions reduces creation of duplicate data.
